(19) United States
(12) Patent Application Publication
(10) Pub. No.: US 2003/0179747 A1
(43) Pub. Date: Sep. 25, 2003

(54) System and method for intercepting telecommunications

(76) Inventors: Craik R Pyke, Nepeah (CA); William Hern, Berkshire (GB); Roger L Thompson, Rtp, NC (US); Serge S Caron, Gatineau (CA); Halima H Mounki, Kanata (CA); Charles B Ewoti, Markdorf (DE); Michael C Goerens, Friedrichshafen (DE); Peter J Streng, Manotick (CA); Christopher J Goertzen, Ottawa (CA); Christian Kittlitz, Ottawa (CA); Richard C. Taylor, Manotick (CA); Michael L Welham, Uberlingen (DE)

Correspondence Address: WITHROW & TERRANOVA, P.L.L.C., P.O. BOX 1287, CARY, NC, 27512, US

(21) Appl. No.: 10/181,288

(22) PCT Filed: Oct. 9, 2001
(86) PCT No.: PCT/US01/31548

(51) Int. Cl. H04L 12/28

(52) U.S. Cl. 370/389

(57) ABSTRACT

A system and method for intercepting a telecommunication signal are generally provided, in which the system and method affect receiving a telecommunication packet, comprising a header and a payload, removing a first header from the packet, replicating the payload and adding a second header to replicated payload and directing the replicated payload to the address associated with the second.

### CROSS REFERENCE TO RELATED APPLICATIONS

This application claims priority to U.S. Provisional Patent Application serial No. 60/239,048, filed Oct. 10, 2000, entitled LAWFUL INTERCEPT VIA CENTRALIZED REPLICATOR and is incorporated herein by this reference.

### BACKGROUND OF THE INVENTION

In law enforcement, it is sometimes necessary to monitor an individual or group of individuals to support allegations of illegal activity. Indeed, many countries mandate that telecommunications service providers and equipment manufacturers provide a law enforcement agency the ability to perform lawful interception of telecommunications to and from a subject being monitored.

Historically, lawful intercept consisted of using alligator clips which a law enforcement agency would physically clip to, thereby tapping into, the telecommunication line of a subject (the monitored party) and monitor calls to or from an associate (a party calling or being called by the subject.)

There are two categories of intercept, call data and call content. Call data intercept includes monitoring call events, for example, monitoring if the subject originates a call, or if a call is terminated on the subject, or if a call is forwarded elsewhere. This type of monitoring, known as pen register, provides the phone number of both the person called and the person calling, along with call events and time-date stamps of when the events occurred. In contrast, call content includes the actual content of the call, i.e., the conversation that takes place, plus call data. Call content is transmitted to the law enforcement agency in real time so that the law enforcement agency can monitor the conversation as it happens. This transmission must be transparent to the subject and the associates so that they are not aware that they are being monitored.

As telecommunications equipment evolved, modules were provided in the telecommunication switch that provided the law enforcement agency the ability to lawfully intercept telecommunications. For example in a Time Division Multiplexed (TDM) switch such as the Nortel Networks DMS-100, a switch network fabric provides an access point that allows a law enforcement agency to tap the subject's phone line. This type of centrally located access point is known as an Intercept Access Point (IAP). The resulting information is then provided to the law enforcement agency.

As telecommunications have evolved to packet based communications, to include Internet Protocol (IP) and Asynchronous Transfer Mode (ATM) protocols, the changing architecture of the telecommunications switches has necessarily made the interception of content more difficult.

In September of 1998, the Federal Communications Committee (FCC) ruled that new TDM equipment must have lawful intercept capability built in. Moreover, in August of 1999 the FCC ruled that packet communications interception capability will be required by Sep. 30, 2001.

Accordingly, there is a need to be able to intercept voice over packet communications in a manner that satisfies governmental requirements, is transparent to the subject and the associate, in real time, and works with standard protocols such as IP and ATM applications.

### SUMMARY OF THE INVENTION

The invention results from the realization that a truly efficient and effective system and method for intercepting voice over packet communications is achieved in which a packet communication signal directed to or from a subject is received by a centralized replicator. The header is stripped from the packet leaving only the payload, the payload is replicated, a header is added to the replicated payload and the replicated payload is transmitted to a Law Enforcement Agency. A header is added to the original payload and the packet is retransmitted to the intended recipient. Alternatively, the entire packet can be replicated and the headers stripped off both the original packet and the replicated packet and a new header added to each payload. The payloads are then transmitted to the intended recipient and the Law Enforcement Agency.

In one embodiment, there is provided a method of intercepting a telecommunication signal including receiving a telecommunication packet comprising a predetermined header and a payload, removing the predetermined header from the packet, replicating the payload, adding a new header to replicated payload and directing the replicated payload to the address associated with the new header.

It can be determined whether a telecommunication packet is to be monitored. The new header can be associated with one of an intended recipient and a law enforcement agency. The predetermined header can be replaced with a second predetermined header. This replacement can occur before or after replication of the payload. The second predetermined header can be associated with the other of the intended recipient and the law enforcement agency. The payload can be directed to the address associated with the second predetermined header.

In another embodiment there is provided a system for intercepting a telecommunication signal. The system includes an audio server, responsive to a telecommunication signal, for receiving a telecommunication packet comprising a predetermined header and a payload, a termination point for removing the predetermined header from the packet, for replicating the payload and for adding a new header to replicated payload and a relay point for directing the replicated payload to the address associated with the new header.

The new header can be associated with one of an intended recipient and a law enforcement agency. There can be a media gateway for directing the telecommunication signal to the audio server and also a media gateway controller, responsive to the media gateway, for determining that the telecommunication packet is to be intercepted. The media gateway controller can include a call discriminator, responsive to the telecommunications signal, for determining that the telecommunication signal is subject to interception. There can be a second termination point for adding a second predetermined header to the payload. The second predetermined header can be associated with the other of the intended recipient and the law enforcement agency. There can be a second relay point for directing the payload to the address associated with the second predetermined header.

In yet another embodiment, there is provided a method for intercepting a telecommunication signal by receiving a telecommunication packet comprising a predetermined header and a payload, removing the predetermined header from the packet, replicating the payload, adding a new header to replicated payload and directing the replicated payload to the address associated with the new header.

It can be determined whether the telecommunication packet is to be intercepted. The new header can be associated with one of an intended recipient and a law enforcement agency. The predetermined header can be removed from the payload and replaced with a second predetermined header. This replacement can occur before or after replication of the payload. The second predetermined header can be associated with the other of the intended recipient and the law enforcement agency. The payload can be directed to the address associated with second predetermined header.

There is further provided a method of redirecting a telecommunication signal. The method includes receiving a telecommunication packet comprising a header and a payload, removing the predetermined header from the packet, adding a second predetermined header to payload and directing the replicated payload to the address associated with the second predetermined header.

It can be determined whether a telecommunication packet is to be redirected. The second predetermined header can be associated with one of an intended recipient and a law enforcement agency. The payload can be replicated. This replication can occur before or after the predetermined header is removed. A new header can be added to the replicated payload and the replicated payload can be directed to the address associated with second predetermined header. The new header can be associated with the other of the intended recipient and the law enforcement agency.

There is still further provided a method of monitoring a telecommunication signal to or from a subject being monitored from or to an associate. The method includes determining that a telecommunication signal is subject to being monitored, establishing a connection between a first gateway associated with one of a subject being monitored and an associate and a first termination point representing a second gateway associated with the other of the associate and the subject, establishing a connection between the second gateway and a second termination point representing the first gateway and establishing a connection between the first termination point and the second termination point to establish a bearer channel between the subject and the associate wherein the first and second gateways appear to be connection directly.

A connection can be established from at least one of the first termination point and the second termination point to a gateway associated with other than the subject and the associate concurrently with the connection between the first termination point and the second termination point.

There is provided even still further a method of redirecting a telecommunications signal intended for one of a subject and an associate by associating a first termination point with a first intended termination point of a first media gateway, associating a second termination point with a second intended termination point of a second media gateway, establishing a connection between the first intended termination point and the second termination point, establishing a connection between the second intended termination point and the first termination point and establishing a connection between the first termination point and the second termination point wherein the first intended termination point and the second termination point appear to be connected directly.

### BRIEF DESCRIPTION OF THE DRAWINGS

FIG. 1 is a schematic block diagram generally representing a system for intercepting packet communications including a centralized replicator according to the present invention;

FIG. 2 is a more detailed schematic block diagram, similar to FIG. 1, including a media gateway controller associated with each media gateway for implementing the necessary connections to affect interception of packet communications;

FIG. 3 is a schematic block diagram, similar to FIG. 1, demonstrating the actual and ephemeral connections when implementing the call intercept according to one aspect of the present invention;

FIG. 4 is a schematic block diagram demonstrating associated connections internal to the centralized replicator for affecting bearer channel tandeming for intercepting packet communications;

FIG. 5 is a schematic block diagram representing bearer channel tandeming by the call discriminator in response to a requirement to intercept packet communications;

FIG. 6 is a flow chart representing one method of intercepting packet communications according to the present invention;

FIG. 7 is a schematic block diagram, similar to FIG. 2, in which a second associate establishes a call to a subject being monitored and a call waiting feature is invoked;

FIG. 8 is a schematic block diagram, similar to FIG. 4, demonstrating the connection topology within the centralized replicator when the call-waiting feature is invoked; and

FIG. 9 is a schematic block diagram, similar to FIG. 8, demonstrating the connection topology within the centralized replicator when a conference call feature is invoked.

### DETAILED DESCRIPTION

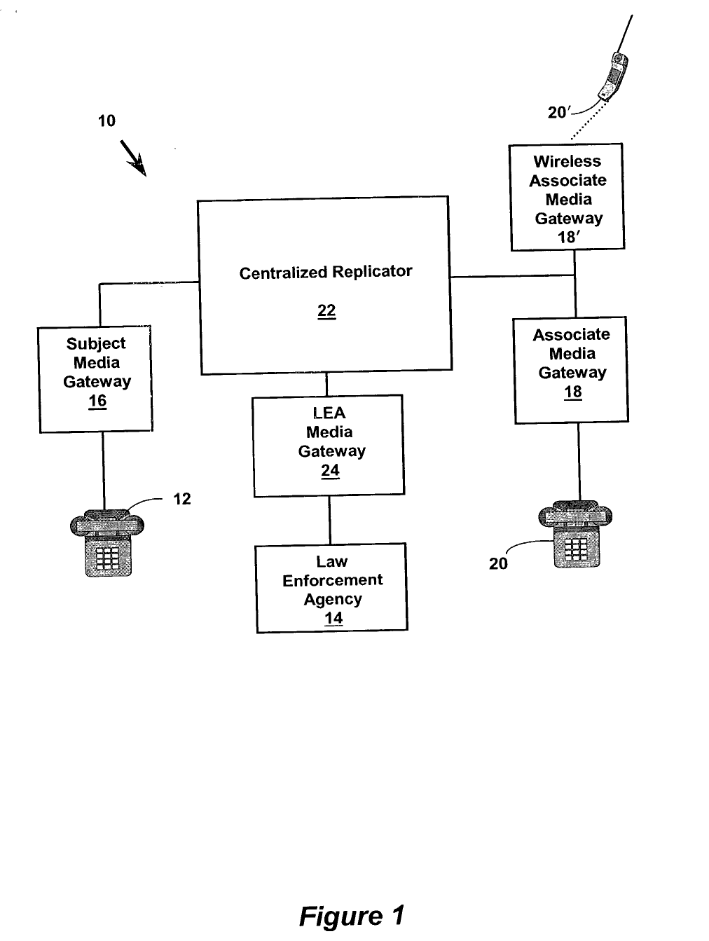

According to the present invention there is generally provided a system 10, FIG. 1, which can intercept a packet telecommunication signal to or from a subject 12 being monitored, for example, by a Law Enforcement Agency (LEA) 14. There is a first, or subject, media gateway 16 associated with subject 12 being monitored and a second, or associate, media gateway 18 associated with an associate 20 who is calling or being called by subject 12. There can also be a wireless associate media gateway 18′ where an associate 20′ is communicating with subject 12 over a wireless phone.

A call is initiated between subject 12 and associate 20. It is determined that the telecommunication signal is one targeted for monitoring and is to be intercepted. Accordingly, for a call from associate 20 to subject 18, the telecommunication signal, rather than being sent directly to the intended associate media gateway 18, is redirected from subject media gateway 16 to a centralized replicator 22 which may, for example, comprise a universal audio server associated with LEA 14. When centralized replicator 22 receives the telecommunication signal, comprised of individual packets with each packet including a header and a payload, centralized replicator 22 removes the header from the packet leaving the payload intact. Centralized replicator 22 replicates the payload, adds a header to the replicated payload and transmits the replicated payload to a law enforcement agency gateway 24. Once the payload has been replicated a header is added to the original payload and that packet is retransmitted by centralized replicator 22 to associate media gateway 18/18′ for delivery to associate 20/20′.

Alternatively, the entire incoming packet can be replicated, including header and payload. Once the packet has been replicated, the headers of the original and replicated packets are removed. A new header is added to the replicated payload for delivery to law enforcement agency 14 and a new header is added to the original payload for delivery to the respective intended recipient, subject 12 or associate 20.

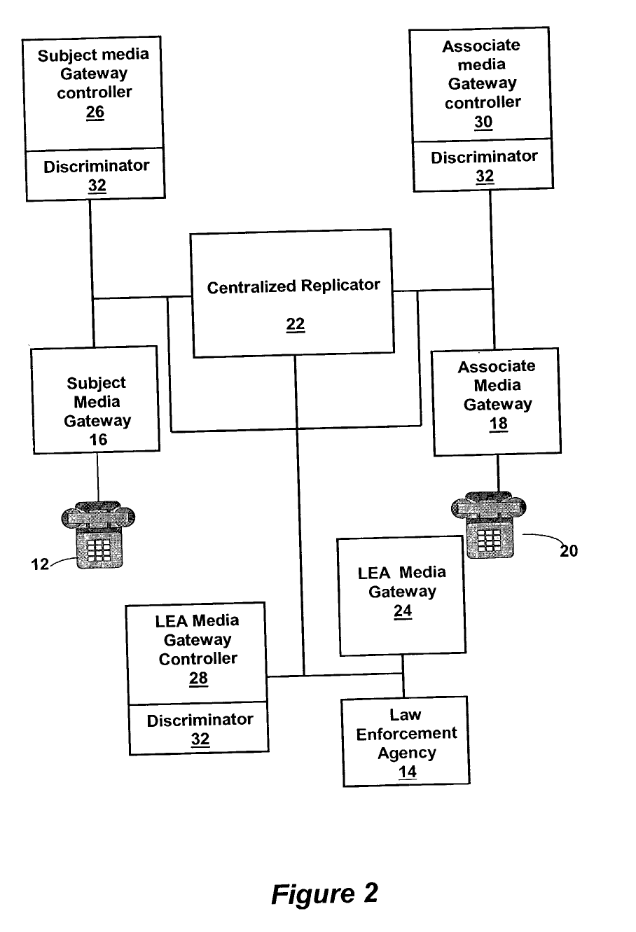

Referring now to FIG. 2, associated with each media gateway 16, 24 and 18, can be a media gateway controller 26, 28 and 30, respectively. As used herein, a media gateway controller refers to one or more devices whose functionality can include performing media gateway control signaling and call processing functions. Each associated gateway controller can include a call discriminator 32 comprising call processing software that determines that a call from or between associated gateways, for example subject media gateway 16 to associate media gateway 18, is in fact subject to monitoring. There can be included within discriminator 32, for example, a lawful intercept database that identifies subscribers, e.g., subject 12, who are subject to a surveillance order.

Once it has been determined that the call is subject to monitoring, subject media gateway controller 26 sends a first message, for example using Media Gateway Control Protocol (MGCP) or H.248 protocol, to LEA media gateway 28 to effect a connection between subject media gateway 16 and centralized replicator 22 and another message to effect a connection between associate media gateway 18 and centralized replicator 22. The redirection of the call through centralized replicator 22 is transparent to call processing and service functions and the call appears to be set up normally as if subject media gateway 16 and associate media gateway 18 were connected directly. The above example assumes that subject 12 and associate 20 do not share a common gateway. However, a shared gateway would not change the operation of the subject invention as call discrimination and packet replication would take place in the same manner, transparent to the caller.

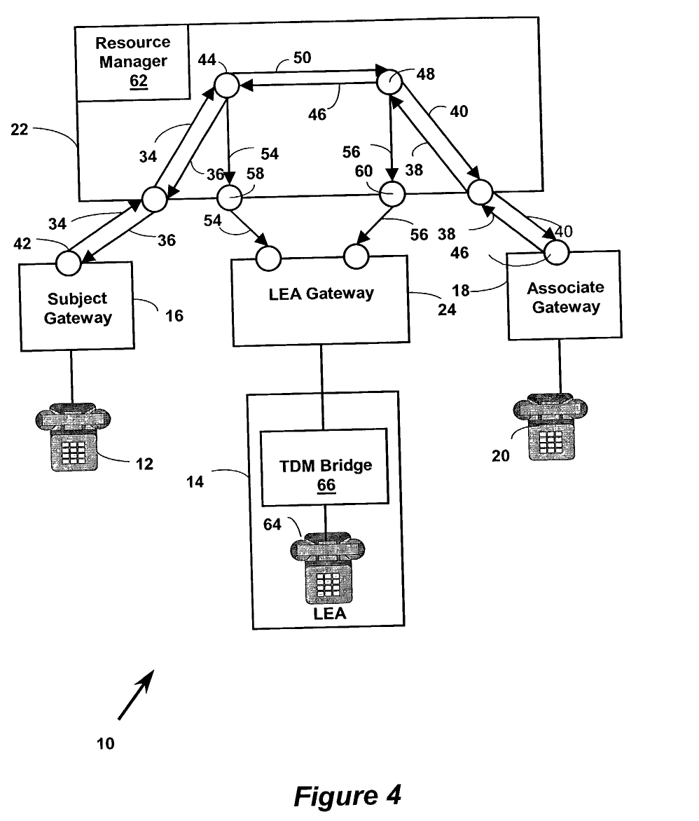

LEA Media gateway controller 28 effects redirection of the call from the intended recipient and instructs centralized replicator 22 to make internal connections, referred to as bearer channel tandeming, in order to facilitate packet replication as will be discussed further in reference to FIG. 4. Once media gateway controller 28 has established the necessary connections between subject media gateway 16, centralized replicator 22 and associate media gateway 18, media gateway controller 28 initiates the connections between centralized replicator 22 and law enforcement agency media gateway 24 which is then connected to LEA 14.

Accordingly, a call subject to monitoring will contain packets whose headers have been altered or substituted such that instead of the packets being transmitted to and from gateways 16 and 18 directly (the intended recipients), the packets are redirected to centralized replicator 22 for replication. Media gateway controller 28 alters the address information of the messages such that it appears to subject media gateway 16 that the message is coming from associate media gateway 18 and messages sent to associate media gateway 18 appear to come from subject media gateway 16.

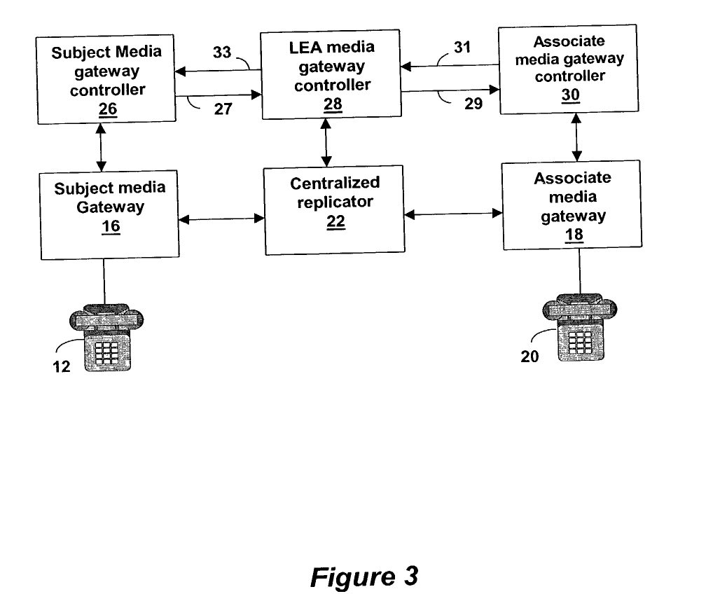

As shown in FIG. 3, subject media gateway controller 26 sends a message 27 with the session description information, for example using a protocol such as the Session Description Protocol (SDP), of subject media gateway 16 to LEA media gateway controller 28. Media gateway controller 28 sends a message 29 including the session information of media gateway 16 to associate media gateway controller 30, but with the address of centralized replicator 22.

Similarly, associate media gateway controller 30 sends a message 31 acknowledging the session description of media gateway 16 with the session description of associate media gateway 18. LEA media gateway controller 28 sends a message 33 acknowledging the session description of subject media gateway 16 with the session description of associate media gateway 18, but with the address of centralized replicator 22.

Accordingly, a communication path from subject media gateway 16 to associate media gateway 18 is tandemed through centralized replicator 22, but is transparent to subject 12 or associate 20.

FIG. 4 further demonstrates how bearer channel tandeming can be accomplished through centralized replicator 22 by modifying the association between packet streams and endpoints to affect the connections and representations demonstrated in FIG. 3.

Packet streams 34, 36, 38 and 40 originate from associated endpoints 42, 44, 46 and 48, respectively. Accordingly, the respective transmit and receive streams 34/36 of endpoint 42, while appearing to be associated with endpoint 46 (associate media gateway 18), are associated with end point 44 within centralized replicator 22. Similarly, respective transmit and receive streams 38/40 of endpoint 46 are associated with end point 48 while appearing to be associated with end point 42 (subject media gateway 16). Finally, internal streams 50 and 52 are associated with end points 44 and 48. Connections to end points 42, 44, 46 and 48 are initiated from media gateway controller 28 (FIG. 3) where endpoints 42 and 46 are the recognized originator and terminator endpoints.

Endpoints 42 and 46 are typically configured to convert the TDM information from subject 12 or associate 20 into, for example, IP or ATM packets or cells depending upon the fabric of centralized replicator 22. Similarly, information received at these endpoints from centralized replicator 22 is converted from IP/ATM to TDM. In contrast, endpoints 44 and 48 within centralized replicator 22 are typically configured only as packet relay points and do not provide any transcoding or jitter correction in order to minimize latency and reduce the risk of detection by subject 12 or associate 20 of the monitoring. Flow control buffers (not shown) can be provided to avoid loosing packets.

Packet relay endpoints 44 and 48, respectively, strip the header off incoming packet streams 34 and 38 that they receive from respective endpoints 42 and 46, replicate the payload, add a new header to the replicated payload and transmit replicated packet streams 54 and 56 to law enforcement agency gateway 24 via endpoints 58 and 60. Packet relay endpoints 44 and 48 also transmit the original payload via streams 50 and 52, respectively, to each other, adding new headers directing the packets to respective gateways 16 and 18. Alternatively, the entire packet may be replicated, then the replicated headers are stripped off and new headers added to redirect the replicated packets to their respective gateways.

In order to ensure transparency to subject 12 and associate 20 of the intercept, streams 54 and 56 destined for law enforcement agency 14 should be unidirectional. Accordingly, endpoints 58 and 60 should be configured as send only in the direction of law enforcement agency gateway 24. Endpoints 58, 60 should be from the same resource pool as endpoints 44 and 48 so that the resource pools reflect what endpoints within centralized replicator 22 have internal connections between them so that media gateway controller 28 can send the appropriate connectivity messages to centralized replicator 22. Accordingly, a resource manager 62 is provided. Moreover, endpoints 58 and 60, as with packet relay endpoints 44 and 48, should achieve a transmission time between endpoints that maintains low latency such that the total trip delay of the packets, including time to traverse centralized replicator 22, does not exceed the engineered threshold of the echo cancellers of the respective media gateways.

Resource manager 62 performs several basic functions to include allocation of resources, returning resources to a free pool and reporting on resources. Resource manager 62 can provide an interface to operating personnel to indicate what resources in centralized replicator 22 are to be used for bearer channel tandeming. The connection to law enforcement agency 14 can occur in several forms to include dedicated lines, switched local links, dedicated trunks or switched remote links without departing from the scope of the invention.

A monitoring point 64 within law enforcement agency 14, which may include an audio device, can receive the call content via a TDM multiplexed mixing bridge 66. Monitoring point 64 receives the call content in real time, thus at the same time subject 12 hears the ring from associate 20, law enforcement agency 14 also hears the ring back. As will be apparent to those skilled in the art, law enforcement agency gateway 24 should be able to support all possible CODEC's that can be negotiated between a subject 12 and an associate 20.

While system 10 has been described as only performing a single replication for a single law enforcement agency, it should be understood that this is not a limitation of the present invention, as the incoming packet streams can be replicated at endpoints 44 and 48 multiple times, depending on the number of law enforcement agencies monitoring subject 12, by configuring the hardware comprising endpoints 44 and 48 for multiple replications.

Despite the changes in the connection messages as described above, neither subject 12 nor associate 20 are provided an indication that the call is being redirected through centralized replicator 22.

When it is determined that a call is to be monitored, the standard connectivity message from the call server can either be altered to perform the appropriate connection or the message can be split into multiple messages to perform the requested connection.

By way of example, the connection operation from the call server requesting a connection between subject 12 and associate 20 is modified into three separate connectivity operations. This is done by requesting separate connections from endpoints 42 and 44, from endpoints 46 and 48 and from endpoints 44 to 48.

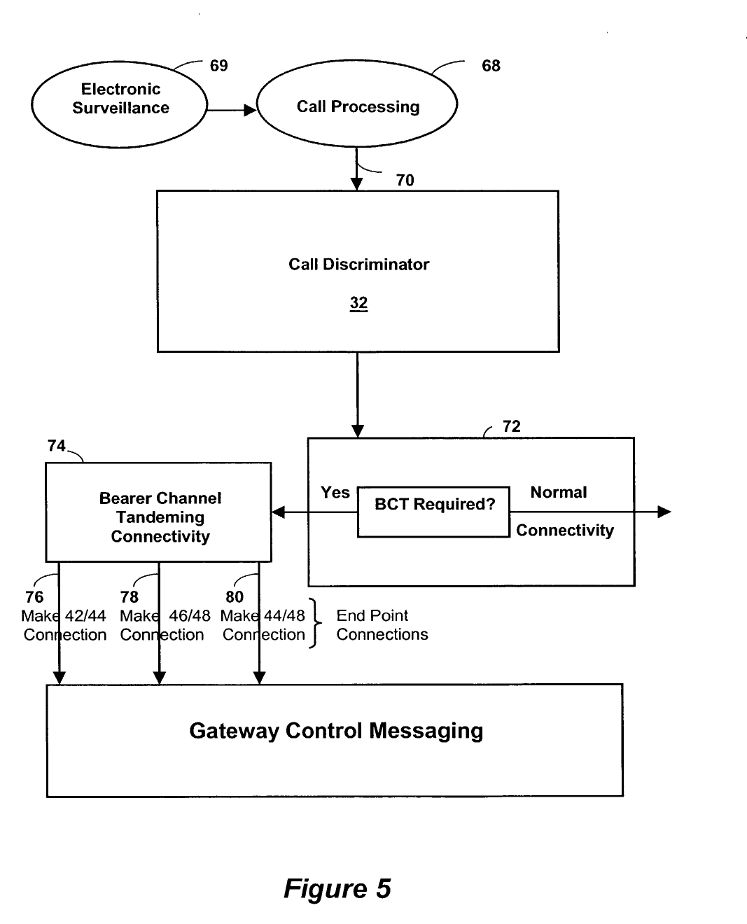

As shown in FIG. 5, a call agent or call processing 68, in response to electronic surveillance software 69, issues a connectivity message 70 to call discriminator 32 to make a subject to associate connection from a discriminator layer in connectivity software 72 to bearer channel tandeming connectivity software 74 which issues three separate media gateway control messages. A first message 76 can initiate a connection from subject media gateway 16 (FIG. 4) to centralized replicator 22. A second message 78 can initiate a connection from associate media gateway 18 to centralized replicator 22. A third message 80 can instruct centralized replicator 22 to make an internal association between the centralized replicator 22 to subject media gateway 16 connection and the centralized replicator 22 to associate media gateway 18 connection.

Once the associated connection between subject 12 and associate 20 has been configured, media gateway controller 28 (FIG. 3) initiates the respective connections to law enforcement media gateway 24 by requesting two connections from endpoints 44 to 58 and 48 to 60 (FIG. 4) within centralized replicator 22 to law enforcement media gateway 24, where endpoints 58 and 60 connect to law enforcement media gateway 24, as illustrated in FIG. 4 above.

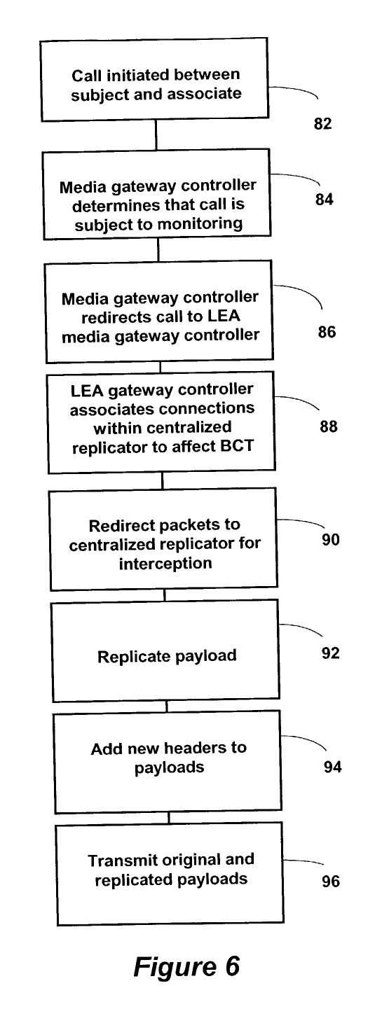

A flowchart of the present invention is presented in FIG. 6. A call is initiated between a subject and an associate, Block 82. The media gateway controller associated with the subject being monitored determines that the call is to be monitored, Block 84, and redirects the call to the media gateway controller of the LEA by associating the LEA media gateway with the destination (associate) media gateway, Block 86. The media gateway controller associated with the law enforcement agency effects bearer channel tandeming by associating the endpoints of the subject and associate media gateways with endpoints within the centralized replicator, Block 88.

Once tandeming of the bearer channel has been affected, packets to and from the subject are redirected to the centralized replicator, Block 90, where the payload is replicated, Block 92, and new headers added to both the replicated payload and the original payload, Block 94. The respective payloads are then transmitted to the recipient subject or associate and the LEA, Block 96.

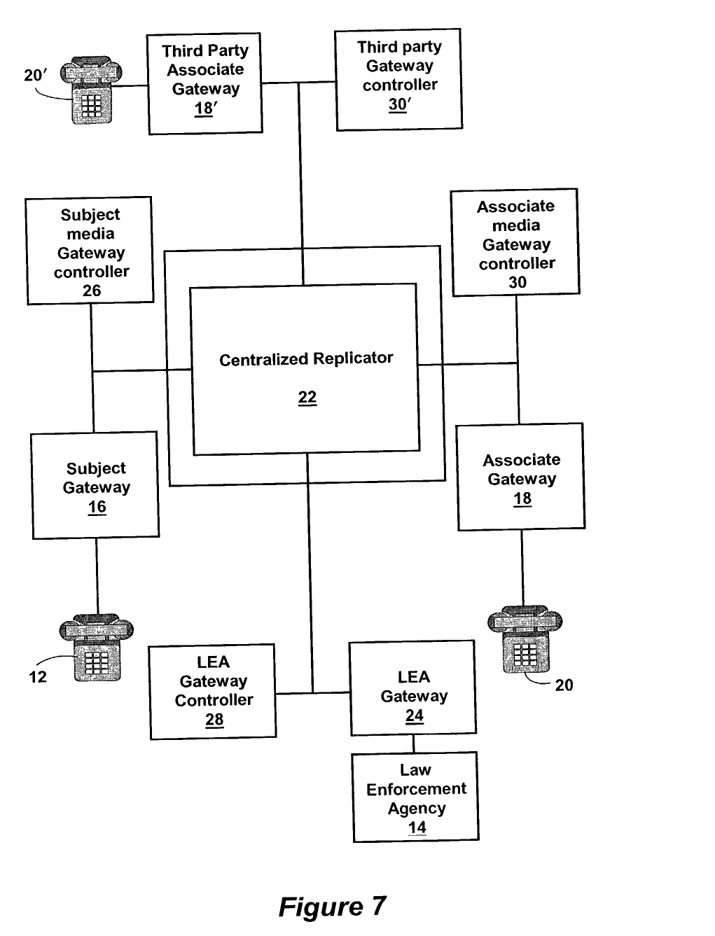

FIG. 7 represents generally the situation where a call-waiting feature is invoked. For illustrative purposes, each agent is serviced by a different media gateway controller. A call is originated between subject 12 and first associate 20, as discussed above, until subject 12 and first associate 20 enter the talking state as discussed above with the law enforcement agency 14 receiving the call content.

A second associate 20′ originates a call to subject 12. Associate media gateway controller 30′ performs call processing routing the call to subject media gateway 16 and it is determined that the call is subject to interception. Centralized replicator 22 recognizes that subject 12 is engaged in an existing call. LEA media gateway controller 28 instructs media gateway 16 to play a call waiting tone to subject 12.

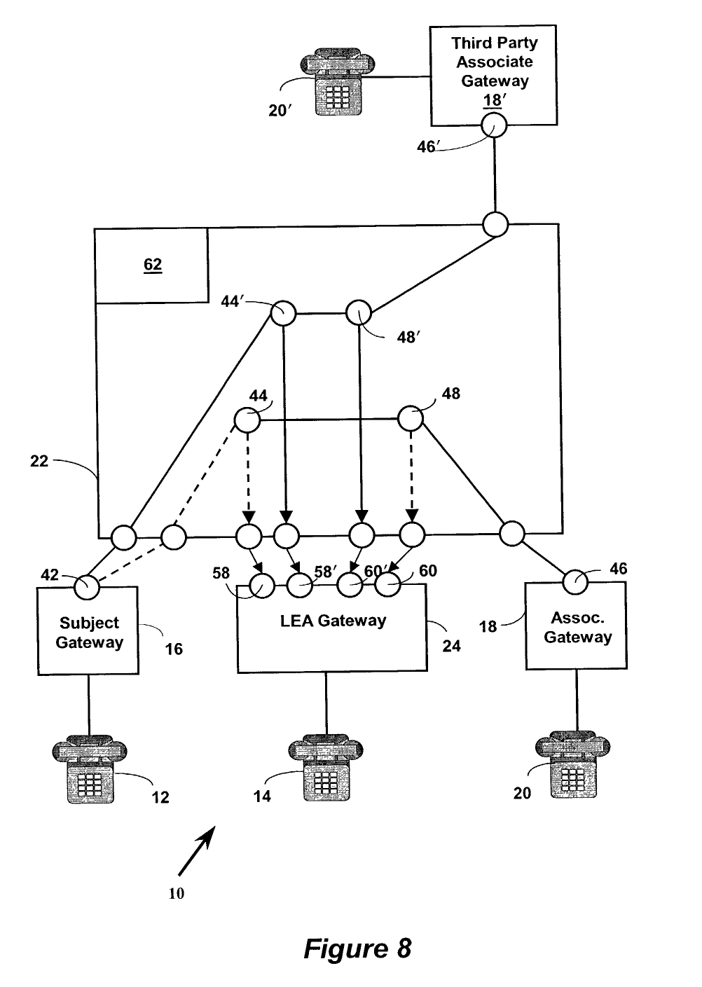

Referring now to FIG. 8, subject 12 invokes a feature flash to receive the call originated by second associate 20′. Subject media gateway controller 26 (FIG. 7) instructs centralized replicator 22 to break the connection between subject 12 and first associate 20. However, Tandeming Connectivity software 74 (FIG. 5) intercepts this message, and alters it to only break the connection between endpoints 42 and 44 (shown in phantom). Electronic Surveillance software 69 (FIG. 5) further requests the connections with LEA 14 be broken and thus the connections between endpoint 44 and 58 and 48 and 60 are broken (shown in phantom), but the connection between endpoints 44 and 48 and 48 and 46 remain in tact.

Tandeming Connectivity software 74 obtains two more endpoints 44′ and 48′ from resource manager 62 to tandem the call between subject 12, second associate 20′ and LEA 14. Tandeming Connectivity software 74 initiates a connection between end points 42 and 44′. Tandeming Connectivity software 74 further initiates a connection between endpoints 44′ and 48′ within centralized replicator 22. The session description information of endpoints 42 and 44′ are exchanged, and the session description information of 44′ and 48′ are exchanged to facilitate the completion of the bearer channel.

Subject media gateway controller 26 acknowledges endpoint 46′ and responds with the session information of endpoint 48′, in order to facilitate the completion of the bearer channel configuration.

At this point a bearer channel is configured between end points 42 and 44′, 44′ and 48′ and 48′ and 46′. Subject 12 and second associate 20′ now enter the talking state with law enforcement agency 14 receiving the call content. Second associate 20′ terminates the call and subject 12 invokes a feature flash to return to first associate 20. Subject media gateway controller 26 sends a message to break the connection between subject 12 and the message is intercepted and altered to only break the connection between end points 42 and 44′. The connection with Law enforcement agency 14 is also broken, but the connections between endpoints 44′ and 48′ and 48′ and 46′ remain intact. Second associate media gateway controller 30′ (not shown) passes a clear forward message to subject media gateway controller 26 instructing connectivity to break the connection with second associate 20′. Tandeming Connectivity software 74 (FIG. 5) intercepts the message and, determining that the other external agent has been removed from the bearer channel tandem, instructs a break of the connections between end points 44′ and 48′, and 48′ and 46′.

Endpoints 44′ and 46′ are returned to resource manager 62 to be reentered into the free pool. Subject media gateway controller 26 (FIG. 7) sends a message to reestablish a connection between subject 12 and first associate 20. Tandeming Connectivity software 74 (FIG. 5) intercepts this message, determines the given communication is already associated with a tandemed connection, and retrieving the endpoints in use, issues connectivity messages to reestablish the connection between endpoints 42 and 44.

The session information of end points 42 and 44 are exchanged as previously discussed completing the bearer channel tandem. Electronic Surveillance software 69 (FIG. 5) requests notification of the endpoints being used to tandem the bearer channel through centralized replicator 22. Endpoints 58 and 60 are then connected to LEA media gateway 24 in order to provide capture of the call content. Subject 12 and associate 20 are again in a talking state through a bearer channel established via endpoints 42 and 44, 44 and 48 and 48 and 46.

Referring to FIG. 7 once again, a conference call feature is established in a manner similar to call waiting. A call is originated between subject 12 and first associate 20. Subject media gateway controller 26 determines that the call is subject to monitoring and bearer channel tandeming is initiated connecting subject media gateway 16 and associate media gateway 18 via centralized replicator 22 as discussed above by LEA media gateway controller 26 associating respective end points within centralized replicator 22 with subject media gateway 16 and associate media gateway 18. A connection is then initiated between end points within centralized replicator 22.

Associate media gateway 18 acknowledges the associated endpoint within centralized replicator 22, as if it were acknowledging subject media gateway 16, as discussed above with reference to FIG. 3, and responds with the session description information of associate media gateway 18 and a bearer channel is configured between endpoints 42, 44, 46 and 48 (FIG. 4).

A connection between law enforcement agency gateway 24 and end points within centralized replicator 22 as discussed in FIG. 4 above, is established. Subject 12 and associate 20 now enter a talking state and law enforcement agency 14 receives the replicated packet streams and monitors the call.

Referring again to FIG. 8, subject 12 can invoke a flash feature and originate or receive a call with a second associate 20′. Subject media gateway controller 26 (FIG. 7) receives a message from the call agent of subject 12 to break the connection with first associate 20, which is intercepted due to the bearer channel tandeming, and media gateway controller 28 sends a modified message to centralized replicator 22 (rather than to associate media gateway 18) to break the connectivity of endpoints 42 and 44 (shown in phantom). Electronic Surveillance software 69 (FIG. 5) further requests the connections with LEA 14 be broken and thus the connections between endpoint 44 and 58 and 48 and 60 are broken (shown in phantom), but the connection between endpoints 44 and 48 and 48 and 46 temporarily remain in tact.

With respect to the new caller, the media gateway determines that the call is subject to monitoring, and two more endpoints 44′ and 48′ within centralized replicator 22 are allocated by resource manager 62 and configured to tandem the call to second associate 20′. A connection is then initiated between endpoints 42 and 44′ and media gateway controller 28 passes the endpoint of 48′ to the media gateway controller 30′ associated with second associate 20′. A connection is then initiated between 44′ and 48′ within centralized replicator 22. The session description information of 42 and 44′ are exchanged and the session description information of 44′ and 48′ are exchanged to facilitate the completion of the bearer channel tandeming.

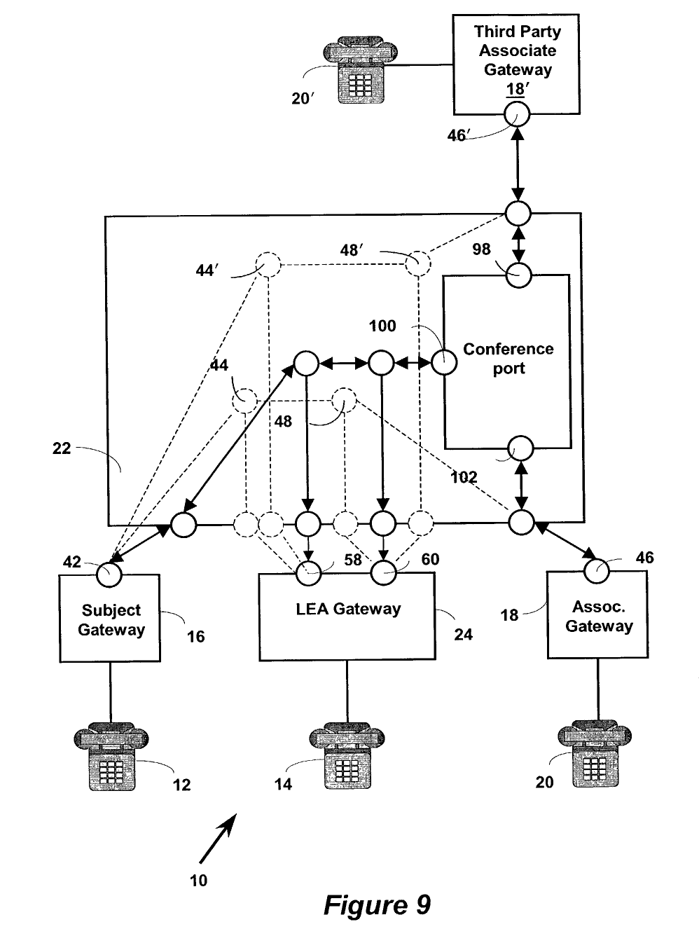

At this point a bearer channel is configured between 42 and 44′, 44′ and 48′, and 48′ and 46′. A connection is then initiated from centralized replicator 22 to LEA 14 via endpoints 44′ and 58′ and 48′ and 60′. Subject 12 can now talk with second associate 20′ and LEA 14 can intercept the content. Subject 12 then invokes a feature flash to join first associate 20 in a three-way call. Connectivity software (FIG. 5) requests that all connections associated with the previous legs be broken (shown in phantom) to enable the three-way call. Accordingly, the connection of end points 44 and 48, 48 and 46 and 44′ and 48′ and 48′ and 46′ are broken along with the corresponding LEA connection and all resources are returned to the resource pool. Media gateway controller 28 requests a connection between subject 12, first associate 20 and second associate 20′ through conferenced ports 98, 100 and 102, as shown in FIG. 9.

What is claimed is:

1. A method of intercepting a telecommunication signal, the method comprising:
(a) receiving a telecommunication packet comprising a predetermined header and a payload;
(b) removing the predetermined header from the packet;
(c) replicating the payload;
(d) adding a new header to replicated payload; and
(e) directing the replicated payload to the address associated with the new header.

2. The method of claim 1 further comprising the step of determining that a telecommunication packet is to be monitored.

3. The method of claim 1 further comprising the step of associating the new header with one of an intended recipient and a law enforcement agency.

4. The method of claim 3 further comprising the step of replacing the predetermined header with a second predetermined header.

5. The method of claim 4 further comprising the step of associating the second predetermined header with the other of the intended recipient and the law enforcement agency.

6. The method of claim 4 in which the step of replacing occurs after the step of replicating.

7. The method of claim 5 further comprising the step of directing the payload to the address associated with the second predetermined header.

8. A system for intercepting a telecommunication signal, the system comprising:
(a) an audio server, responsive to a telecommunication signal, for receiving a telecommunication packet comprising a predetermined header and a payload;
(b) a termination point for removing the predetermined header from the packet, for replicating the payload and for adding a new header to replicated payload; and
(c) a relay point for directing the replicated payload to the address associated with the new header.

9. The system of claim 8 further comprising a media gateway for directing the telecommunication signal to the audio server.

10. The system of claim 8 in which the new header is associated with one of an intended recipient and a law enforcement agency.

11. The system of claim 9 further comprising a media gateway controller, responsive to a media gateway, for determining that a telecommunication packet is to be intercepted.

12. The system of claim 11 in which the media gateway controller includes a call discriminator, responsive to the telecommunications signal, for determining that the telecommunication signal is subject to interception.

13. The system of claim 12 further comprising a second termination point for adding a second predetermined header to the payload.

14. The system of claim 13 in which the second predetermined header is associated with the other of the intended recipient and the law enforcement agency.

15. The system of claim 14 further comprising a second relay point for directing the payload to the address associated with second predetermined header.

16. A method of intercepting a telecommunication signal, the method comprising:
(a) receiving a telecommunication packet comprising a predetermined header and a payload;
(b) removing the predetermined header from the packet;
(c) replicating the payload;
(d) adding a new header to replicated payload; and
(e) directing the replicated payload to the address associated with the new header.

17. The method of claim 16 further including the step of determining that a telecommunication packet is to be intercepted.

18. The method of claim 16 further comprising the step of associating the new header with one of an intended recipient and a law enforcement agency.

19. The method of claim 18 further including the step of replacing the predetermined header removed from the payload with a second predetermined header.

20. The method of claim 19 further comprising the step of associating the second predetermined header with the other of the intended recipient and the law enforcement agency.

21. The method of claim 19 in which the step of replacing occurs after the step of replicating.

22. The method of claim 20 further comprising the step of directing the payload to the address associated with second predetermined header.

23. A method of redirecting a telecommunication signal, the method comprising:
(a) receiving a telecommunication packet comprising a header and a payload;
(b) removing the predetermined header from the packet;
(c) adding a second predetermined header to payload; and
(d) directing the replicated payload to the address associated with the second predetermined header.

24. The method of claim 23 further comprising the step of determining that a telecommunication packet is to be redirected.

25. The method of claim 23 further comprising the step of replicating the payload.

26. The method of claim 25 wherein the step of replicating includes replicating the payload before the predetermined header is removed.

27. The method of claim 23 further comprising the step of associating the second predetermined header with one of an intended recipient and a law enforcement agency.

28. The method of claim 27 further comprising the step of adding a new header to the replicated payload.

29. The method of claim 28 further comprising the step of associating the new header with the other of the intended recipient and the law enforcement agency.

30. The method of claim 29 further comprising the step of directing the replicated payload to the address associated with the new header.

31. A method of monitoring a telecommunication signal to or from a subject being monitored from or to an associate, the method comprising the steps of:
(a) determining that a telecommunication signal is subject to being monitored;
(b) establishing a connection between a first gateway associated with one of a subject being monitored and an associate and a first termination point representing a second gateway associated with the other of the associate and the subject;
(c) establishing a connection between the second gateway and a second termination point representing the first gateway; and
(d) establishing a connection between the first termination point and the second termination point to establish a bearer channel between the subject and the associate wherein the first and second gateways appear to be connection directly.

32. The method of claim 31, further comprising the step of establishing a connection from at least one of the first termination point and the second termination point to a gateway associated with other than the subject and the associate concurrently with the connection between the first termination point and the second termination point.

33. A method of redirecting a telecommunications signal intended for one of a subject and an associate, the method comprising:
(a) associating a first termination point with a first intended termination point of a first media gateway;
(b) associating a second termination point with a second intended termination point of a second media gateway;
(c) establishing a connection between the first intended termination point and the second termination point;
(d) establishing a connection between the second intended termination point and the first termination point; and
(e) establishing a connection between the first termination point and the second termination point wherein the first intended termination point and the second termination point appear to be connected directly.
